(19) United States
(12) Patent Application Publication
(10) Pub. No.: US 2004/0192352 A1
(43) Pub. Date: Sep. 30, 2004

(54) Energy efficient object location reporting system

(75) Inventors: Jari Vallstrom, Oulu (FI); Harri Lilja, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/396,928

(22) Filed: Mar. 25, 2003

(51) Int. Cl. H04Q 7/20; H04M 1/00; G01S 1/00

(52) U.S. Cl. 455/456.6; 455/574; 455/127.5; 455/466; 342/357.09; 342/357.12; 342/357.1; 342/357.07

(57) ABSTRACT

An object location tracking device (10) is constructed to include a battery (10D), a movement sensor (10E), a GSM engine (10A) and a radio frequency (RF) transceiver (10B). The tracking device, in response to the movement sensor sensing a cessation of movement, transmits a message that results in initiating a location determination operation via the RF transceiver to a GSM network (12). The tracking device may transmit data representing its current location to the GSM network. The tracking device thereafter places at least the GSM engine into a reduced battery power consumption mode of operation. In one embodiment the message transmitted by the location tracking device is, as examples, a SMS message or a GPRS message that contains an alpha string that requests the location application server to cause the GSM network to initiate a Mobile Terminated Location Request operation for the tracking device.

### TECHNICAL FIELD

This invention relates generally to wireless telecommunications systems and, more specifically, relates to wireless communications systems that employ location reporting services for determining and indicating a position of a wireless terminal device.

### BACKGROUND

A feature of many modem wireless telecommunications systems, such as digital cellular telecommunications systems, is a location reporting service wherein the position of a wireless terminal can be determined and reported by the terminal, such as by using the Global Positioning Satellite (GPS) system, or determined and reported by the wireless network. Exemplary U.S. Patents that relate to this technology include commonly assigned U.S. Pat. No. 5,960,345, “Location Updating in a Cellular Radio System”, J. Laatu; U.S. Pat. No. 6,061,561, “Cellular Communication System Providing Cell Transmitter Location Information”, S. Alänärä et al.; U.S. Pat. No. 6,397,073, “Method of Locating Terminal, and Cellular Radio System”, A. Hottinen; U.S. Pat. No. 6,397,074, “GPS Assistance Data Delivery Method and System”, K. Pihl et al.; U.S. Pat. No. 6,442,392, “Method and Arrangement for Locating a Mobile Station”, V. Ruutu et al.; and U.S. Pat. No. 6,484,031, “Locating Method and Arrangement”, V. Ruutu et al.

Reference in this regard can also be made to various published cellular telephone system standards, including as examples: 3GPP TS 04.31 V7.7.0 (2001-09), “3rd Generation Partnership Project; Technical Specification Group GSM EDGE Radio Access Network; Location Services (LCS); Mobile Station (MS)-Serving Mobile Location Centre (SMLC) Radio Resource LCS Protocol (RRLP) (Release 1998)”; as well as “3rd Generation Partnership Project; Technical Specification Group Services and Technical Aspects; Digital Cellular Telecommunications System (Phase 2+); Location Services (LCS); (Functional Description)-Stage 2 (Release 1998)”.

Through the use of such location services there is provided an ability to determine a current location of a wireless terminal, such as a cellular telephone, and thus by default a location of a person and/or a vehicle carrying the cellular telephone. This location determining capability enables a number of useful applications, including an ability to locate a person making an emergency telephone call, such as a 911 call, within the coverage area of a wireless network provider.

A location tracking technology directed specifically to vehicles is also known, as exemplified by U.S. Pat. No. 5,880,958, “Method and Apparatus for Freight Transportation Using a Satellite Navigation System”, Helms et al.; and U.S. Pat. No. 5,974,356, “System and Method for Determining Vehicle Travel Routes and Mileage”, Doyle et al., both of which are assigned to Qualcomm Incorporated.

Another location-determining wireless technology is one that uses radio frequency identification (RFID) tags and readers. Representative U.S. Patents in this area include U.S. Pat. No. 5,565,858, “Electronic Inventory System for Stacked Containers”, Guthrie; U.S. Pat. No. 6,486,780, “Applications for Radio Frequency Identification Systems”, Garber et al.; U.S. Pat. No. 6,496,806, “Method and System for Tracking Clustered Items”, Horwitz et al.; and U.S. Pat. No. 6,623,752, “RFID Reader and Communications Apparatus, and Delivery Article Sorting Method and System Using RFID Reader and Communications Apparatus”, Nishitani et al. The RFID system, however, has a limited range for determining the location of objects having RFID tags attached.

In any type of location determining and reporting system that uses a battery powered location device or terminal is the efficient use of battery power. If the battery power is not efficiently and intelligently utilized, the time between battery recharging or replacement operations reduced, thereby adversely affecting the continues operation of the system.

Also of interest to this invention is U.S. Pat. No. 6,067,460, “Mobile Station Having Enhanced Standby Mode”, S. Alänärä et al., wherein when a mobile station is in a DCCH camping state it monitors its assigned page frame. After making RSSI, and possibly also Bit Error Rate/Word Error Rate (BER/WER) measurements, the mobile station monitors the rate of change of the RSSI. If the rate of change is small and remains so, the mobile station is assumed to be in a stationary state. After determining that it is stationary, the mobile station may give an audible alert and/or display a message to request the user to confirm that the mobile station is (and will remain) stationary. When in the stationary state the mobile station inhibits making neighbor channel measurements for DCCH reselection, thereby conserving battery power. The mobile station continues to monitor its assigned page frame within an assigned digital control channel and to measure its own channel RSSI, and possibly also the BER/WER. If these values subsequently indicate that the mobile station is no longer stationary, the mobile station resumes neighbor channel measurements. In one embodiment the mobile station can include a motion sensor, such as a three-axis accelerometer, for detecting when it becomes stationary, and in another embodiment can use a GPS function.

### SUMMARY OF THE PREFERRED EMBODIMENTS

The foregoing and other problems are overcome, and other advantages are realized, in accordance with the presently preferred embodiments of these teachings.

In accordance with this invention, before a tracking device turns off its RF transceiver in an Energy Save mode, such as when it detects a lack of movement, it updates its current location to a location server. There are various methods to perform the update operation.

In a first method, Mobile Originated Location Request (MO-LR), the tracking device initiates the location definition. The actual location can be calculated in the network (tracking device assisted), or in the tracking device itself (tracking device based). The location information is forwarded to the location server. The location forwarding operation may be supported by the wireless network in the MO-LR request, or the location could may be sent as a separate message.

In a second method, executed when the MO-LR is not supported by the wireless network or by the tracking device, the tracking device sends a message, such as a SMS message, to the location server. The location server then initiates a location request operation from the wireless (e.g., GSM) network. The tracking device eventually sees this location request as a Mobile Terminated Location Request (MT-LR). The actual location can be calculated in the network (tracking device assisted), or in the tracking device itself (tracking device based). The location information is forwarded to the location server. The location forwarding operation may be supported by the wireless network in the MT-LR request, or the location could may be sent as a separate message, such as a separate short message (SM).

In a further mode of operation the tracking device may include a movement detector or movement sensor, and can be used for powering down or off external electronic circuits, such as a GPS receiver. In the case where an Energy Save mode only turns off the GPS circuitry, the latest GPS coordinates before power off may be forwarded to the location server for storage, or by using a data message (e.g. GPRS, SMS message) to the location server, or the latest GPS location can be saved in the tracking device. In the latter case the tracking device can promptly reply with the stored location coordinates when requested by the wireless network, even if the GPS receiver is not yet fully operational, or if a currently executed GPS location calculation has not yet completed.

The further mode of operation described in the preceding paragraph applies as well to a mobile phone, such as a cellular telephone, that includes a GPS receiver and a some type of motion sensor.

A method is disclosed to operate an object location tracking system that includes a wireless network. The method includes (a) associating a tracking device with the object, the tracking device comprising a movement sensor; (b) in response to sensing a cessation of movement, transmitting a message from the tracking device towards the wireless network, the message requesting that the wireless network query the tracking device for its current location; (c) in response to receiving the query, sending the current location towards the location server; and (d) placing at least a portion of the tracking device into a reduced power consumption mode of operation. This method is particularly beneficial when a Mobile Originated Location Request is not supported by one or both of the tracking device or wireless network.

Also disclosed is a method to operate the object location tracking system with the wireless network, when the Mobile Originated Location Request is supported by both of the tracking device and the wireless network. This method includes (a) associating the tracking device with the object, the tracking device comprising a movement sensor; (b) in response to sensing a cessation of movement, transmitting a message from the tracking device towards the wireless network, the message containing the current location of the tracking device; and (c) placing at least a portion of the tracking device into a reduced power consumption mode of operation.

Also disclosed is an object location tracking system that includes a tracking device for associating with an object to be tracked. The tracking device includes the movement sensor, a cellular network-compatible engine and a radio frequency (RF) transceiver. The system further includes a cellular network having a mobile station location function and a location application server that is bidirectionally coupled to the wireless network. The tracking device operates, in response to the movement sensor sensing a cessation of movement, for transmitting a message via the RF transceiver to the cellular network, the message requesting that the cellular network query the tracking device for its current location and, in response to receiving the query via the RF transceiver, transmits data representing the current location to the cellular network. The location data can be transmitted to the location application server. The tracking device then places at least a portion of the tracking device into a reduced power consumption mode of operation.

In one embodiment the message sent from the tracking device is a Mobile Originated Location Request, while in another embodiment the message includes an alphanumeric string that requests the location application server to cause the wireless network to send the query as the Mobile Terminated Location Request.

This invention also provides an object location tracking device that is constructed to include a battery, a movement sensor, a GSM engine and a radio frequency (RF) transceiver. The tracking device, in response to the movement sensor sensing a cessation of movement, transmits a message, such as a Mobile Originated Location Request message, via the RF transceiver to a GSM network. Location information representing the current location of the tracking device is forwarded to the location application server. The tracking device thereafter places at least the GSM engine into a reduced battery power consumption mode of operation.

In another embodiment the message transmitted by the location tracking device may be, as examples, a SMS message or a GPRS message that contains an alpha string that requests the location application server to cause the GSM network to transmit the Mobile Terminated Location Request message to the tracking device.

This invention also provides a method to operate a mobile station with a wireless network. The method includes, (a) in response to sensing a cessation of movement of the mobile station, storing data representing a current location of the mobile station in a memory of the mobile station; (b) placing at least a location determining system of the mobile station into a reduced power consumption mode of operation and (c) in response to receiving a request for the mobile station's location from the wireless network, responding with the stored data.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a simplified block diagram of a cellular-based location determining, tracking and notifying system that includes a tracking device suitable for practicing this invention;

FIG. 2 is a more detailed block diagram of the cellular-based location determining, tracking and notifying system of FIG. 1, showing in greater detail various wireless network components;

FIG. 3A illustrates one example of signal flow between various elements shown in FIG. 2 for the case of a Mobile Terminated Location Request (MT-LR);

FIG. 3B illustrates one example of signal flow between various elements shown in FIG. 2 for the case of a Mobile Originated Location Request (MO-LR);

FIG. 4 shows an example of signal flow when the tracking device senses motion; and

FIG. 5 shows an example of signal flow when the tracking device senses a cessation of motion.

### DETAILED DESCRIPTION OF THE PREFERRED EMBODIMENTS

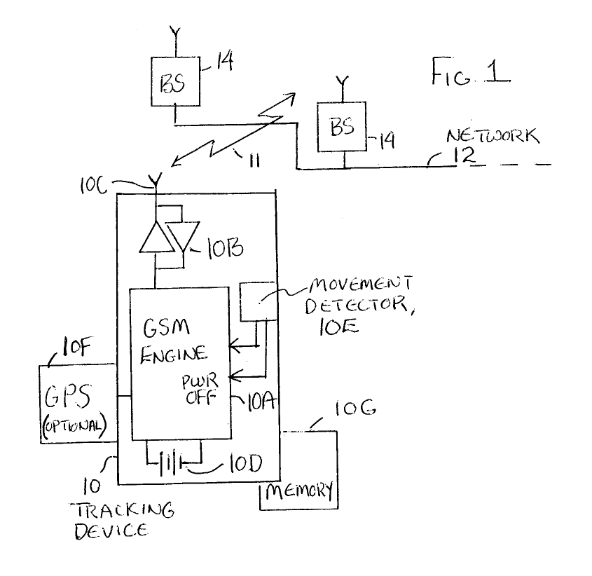

The teachings of this invention will be described in the context of a cellular-based location determining, tracking and notifying system 1. Referring to FIG. 1, in the presently preferred embodiment of the system 1 a simple and low cost tracking device 10 is based on GSM cellular telephone technology device, and is capable of bidirectional RF communications with a cellular network 12 via one or more base stations 14. The tracking device 10 is attached to or otherwise associated with an object of interest (not shown), such as a vehicle, an art work, an animal, a person, or any other suitably-sized object that is capable of movement, or of being moved. The tracking device 10 is preferably dedicated for tracking, location and position change (delta position) notification purposes, and is not intended for use in making telephone calls. As such, the tracking device 10 need not have any audio circuitry (e.g., speaker, microphone), nor any type of sophisticated user interface (UI), e.g., it does not required a LCD display or a keypad. The tracking device 10 does include, in the presently preferred embodiment, a GSM core or GSM engine 10A, and a wireless (RF) transceiver 10B coupled to an antenna 10C for communicating over an RF link 11 using, in the preferred embodiment, GSM signaling and messaging protocols and formats. The tracking device 10 is preferably powered by a suitable battery 10D. The tracking device 10 also includes some type of movement detector or sensor 10E, such as an accelerometer, or any suitable type of device for sensing a movement of the tracking device 10. The tracking device 10 may also include a location detecting device, such as an optional GPS receiver 10F. Note that in some embodiments the RSSI monitoring technique disclosed in the above-referenced U.S. Pat. No. 6,067,460 maybe used to detect motion of the tracking device 10. Also, in an embodiment where the optional GPS receiver 10F is present, the GPS receiver 10F may be used as the movement detector or sensor 10E to sense a cessation of movement, such as when two successive location determinations are the same. This approach is not preferred, however, as it consumes significant power, especially if the GPS receiver 10F must be periodically switched on to determine if the location has changed and, thus, if movement has occurred.

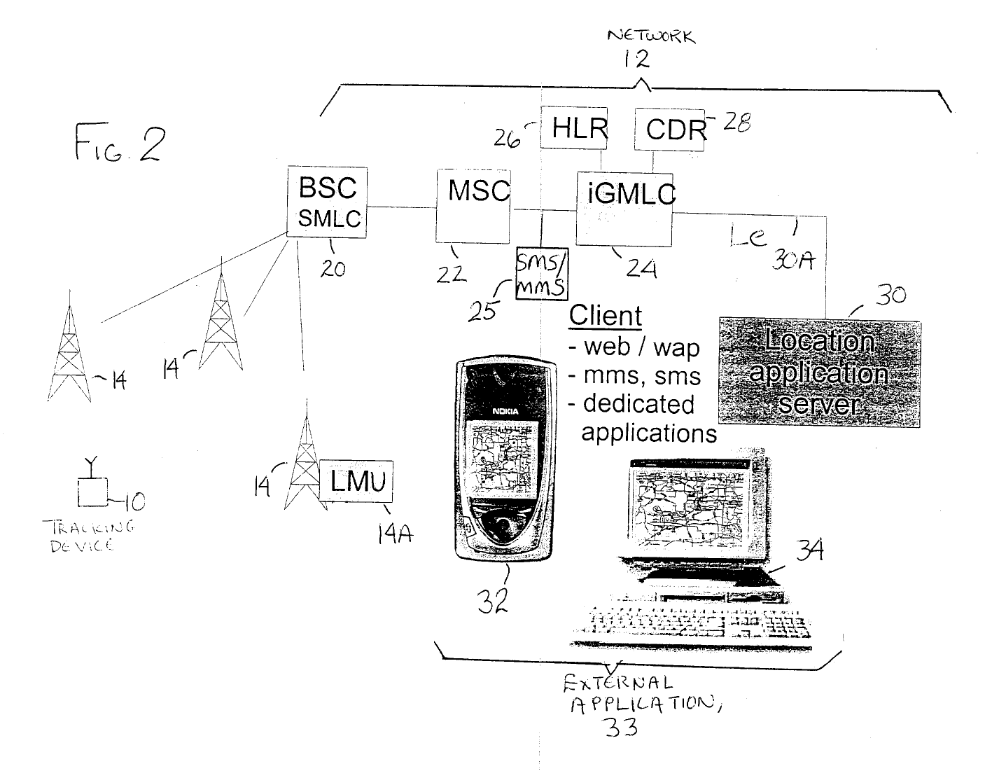

A memory 10G is also included for storing required data, including a predetermined set of SMS messages used by the tracking device 10 when communicating with a Location Application Server 30 (shown in FIG. 2 and described in further detail below).

It is pointed out that a number of different location methods are known and can be used by this invention. As an example, and with regard to LCS in the GSM system (both Release 1998 and Release1999), the LCS methods include: Cell Coverage and Timing Advance (as a back-up method), Time Of Arrival (TOA), Enhanced Observed Time Difference (E-OTD), Stand-alone GPS and Assisted GPS (network based and mobile based). There are two basic architectures: NSS architecture (location calculation in the Network Sub System(NSS)), and BSS architecture (location calculation in the Base Station System (BSS)). The supported cases are: Mobile Terminated Location Request; Mobile Originated Location Request; Network Induced Location Request; and support only in the circuit switched domain.

E-OTD can be implemented in various ways, each having an effect on the Serving Mobile Location Center (SMLC) 20 shown in FIG. 2. It should be noted in the following discussion that MS refers to Mobile Station which, for the purposes of this invention, is assumed to include the tracking device 10 as it contains the functional GSM engine 10A. A first E-OTD technique is MS assisted with MT-LR. In this case a triangulation calculation is performed in the network, and the measurement is triggered by a request from the network (Mobile Terminated Location Request). A second technique is MS assisted with MT-LR and MO-LR. In this case the triangulation calculation is performed in the network, and the measurement is triggered by a request from the network (Mobile Terminated Location Request). The measurement can also be triggered by the MS (Mobile Originated Location Request). A third technique is MS based with MT-LR and MO-LR. In this case the triangulation calculation is performed in the MS. The measurement is triggered by a request from the network (Mobile Terminated Location Request), or the measurement can be triggered by the MS (Mobile Originated Location Request).

Reference can also be made to the Assistance Data, as defined in GSM 04.35. A first data message is an E-OTD Assistance Data Message. The E-OTD Assistance Data contains the RTD and BTS coordinates of the neighbor base stations that should be used in E-OTD measurements. The E-OTD Assistance Data is broadcast on the Cell Broadcast Channel (CBCH) using the SMS-CB (Cell Broadcast) DRX (Discontinuous Reception) service. The reception of this broadcast message enables the MS to calculate its own location. A second data message is the GPS Assistance Data Message. The GPS Assistance Data Message contains GPS differential corrections. The reception of this broadcast message enables the MS to calculate a more accurate location estimate.

On the network side, the SMLC 20 is responsible for gathering the information, constructing the broadcast messages and ciphering a part of the message, if necessary. The SMLC 20 also maintains the deciphering keys that the MS requests with a MO-LR. The deciphering keys are location area specific.

The SMSCB messages can be received when the MS is in the idle mode. When the MS is in the dedicated mode the same information that was received in the idle mode via the broadcast channel may be requested by the MS via point-to-point messaging.

The Assisted GPS (A-GPS) also can assume different forms. For the case of MS assisted A-GPS, the MS sends the information to the network, the triangulation calculation is performed by the network, and the result can be transferred back to the MS or to an application. For the case of MS based A-GPS, the MS sources the satellite data from the network, the triangulation calculation is performed by the MS, and the result can be transfered to a remote application. In a hybrid approach, and by example, one could use AFLT (CDMA E-OTD) and A-GPS. This tends to provide better coverage indoors, and is (currently) MS assisted.

It should be noted, however, that the teachings of this invention are not restricted for use with a GSM-type cellular system, and that other types of digital cellular systems, including as examples only, IS-136, code division multiple access (CDMA) and wideband CDMA (WCDMA) type systems, may be used as well. In general, this invention can be used in TDMA-based systems, CDMA-based systems, and in WCDMA-based systems. Furthermore, and as will be made apparent below, at least certain aspects of this invention can be employed by mobile stations, such as cellular telephones, that do have voice and/or data transmission and reception capabilities.

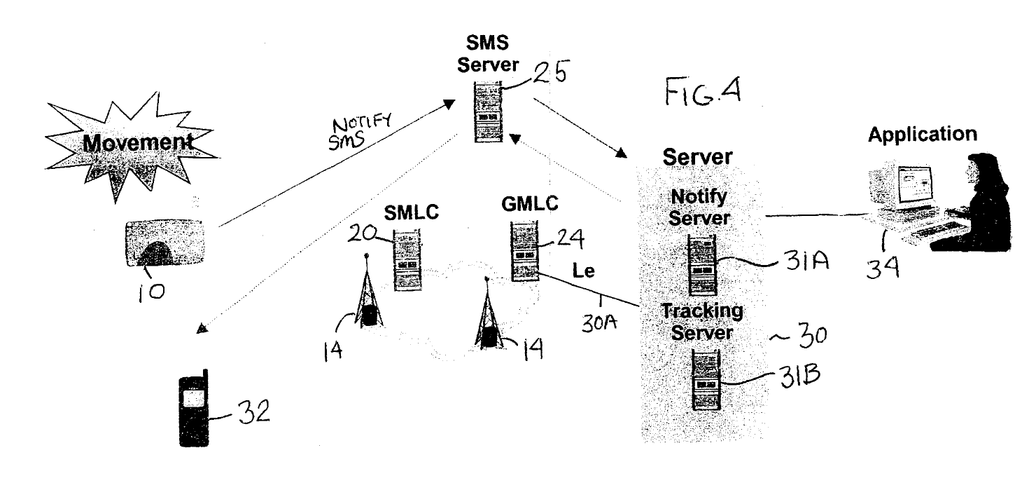

Referring to FIG. 2, the presently preferred cellular-based location determining, tracking and notifying system 1 is constructed to conform to a client-server architecture where tracking device 10 is the client, and where a Location Application Server (LAS) 30 functions as the server. The service chain includes the tracking device 10, a GSM access network that includes the base stations 14 and a Base Station Controller (BSC)/Serving Mobile Location Center (SMLC) 20, a Mobile Switching Center (MSC) 22, a GSM location infrastructure that includes at least one Location Management Unit (LMU) 14A and a Gateway Mobile Location Center (GMLC) 24 (and associated Home Location Register (HLR) 26 and Charging Data Record (CDR) 28), a Short Message Service (SMS)/Mobility Management Service (MMS) function 25, shown more simply as a SMS server 25 in FIG. 4, the LAS 30 (the server), and an external application 33 (the client) embodied as an end user mobile station (MS) 32 and/or a computer, such as a PC 34. The external application 33 is assumed to include various functions, such as one or more of internet/wireless applications protocol (WAP) functions, MMS and SMS functions, and possibly dedicated applications.

In the presently preferred embodiment of the cellular-based location determining, tracking and notifying system 1 there is no direct connection between the external application 33 and the tracking device 10. All messaging, such as SMS, goes through and is mediated by the LAS 30. The tracking device 10 communicates with the LAS 30 using the set of specified SMS messages stored in the memory 10G. The LAS 30, in turn, communicates with the external application 33, such as the end user MS 32, using a possibly different set of SMS messages that are specified by the wireless network 12 service provider. The LAS 30 thereby functions at least in part as a SMS message translator, enabling the service provider to construct the location service to have a desired look and feel, and thus provide distinctions between similar location services provided by other service providers.

In operation, when the LAS 30 (or a user coupled to the LAS 30 via the external application 33), queries the current location of the tracking device 10, the LAS 30 makes a location request via an Le interface 30A (location application LAS 30—GMLC 24). The response depends in part on whether the network 12 supports the Enhanced Observed Time Difference (E-OTD) function. Assuming that E-OTD is supported, a first E-OTD case involves one that is TD-assisted with MT-LR, where a triangulation calculation is performed in the network 12, and where the measurement is triggered by a request from the network (Mobile Terminated Location Request). A second case involves TD-assisted with MT-LR and MO-LR. In this case the triangulation calculation is performed in the network 12, the measurement is triggered by a request from the network 12 (Mobile Terminated Location Request), or the request can be triggered by the TD 10 (Mobile Originated Location Request). A third case involves TD-based with MT-LR and MO-LR. In this case the triangulation calculation is performed in the TD 10 by the GSM engine 10A, the measurement is triggered by a request from the network 12 (Mobile Terminated Location Request), or the measurement can be triggered by the TD 10 (Mobile Originated Location Request). However, some wireless networks do not support E-OTD, but only a sub-set thereof (e.g., MT-LR).

Assume first that the GSM network 12 performs a Mobile Terminated Location Request (MT-LR) for the tracking device 10, and the GMLC 24 responds to the LAS 30 with, for example, World Geodetic Survey 1984 (WGS-84) formatted coordinates of the current tracking device 10 location, as received from the tracking device 10 in response to the MT-LR.

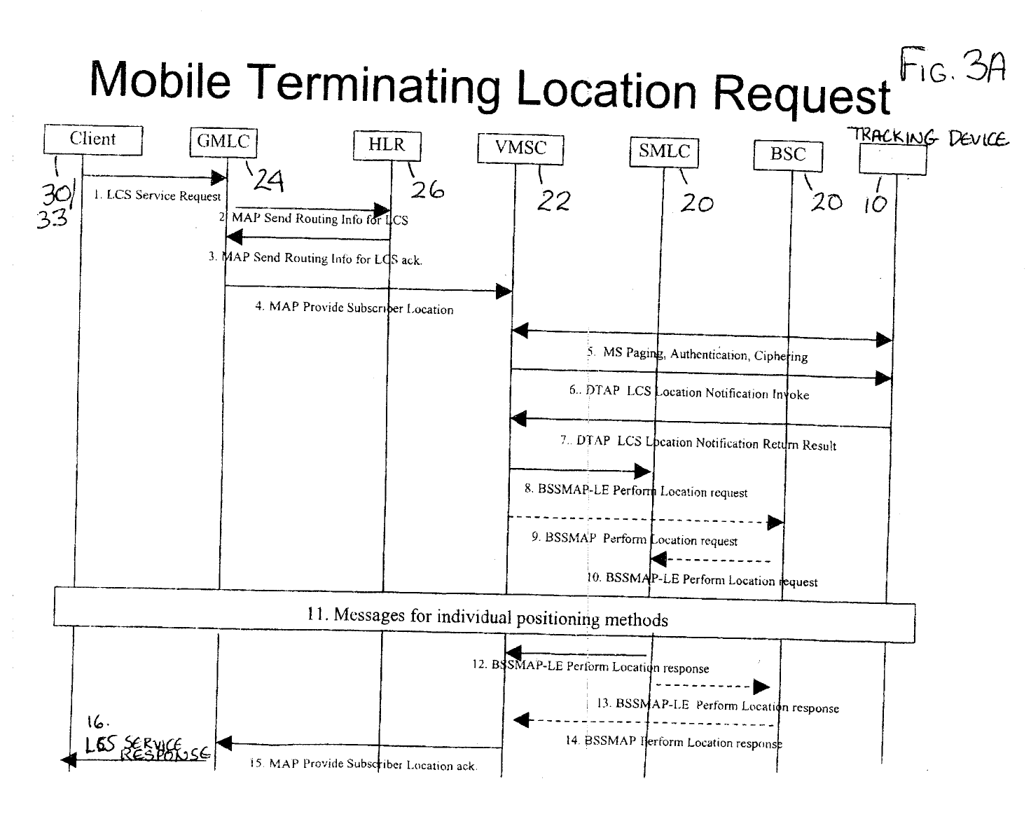

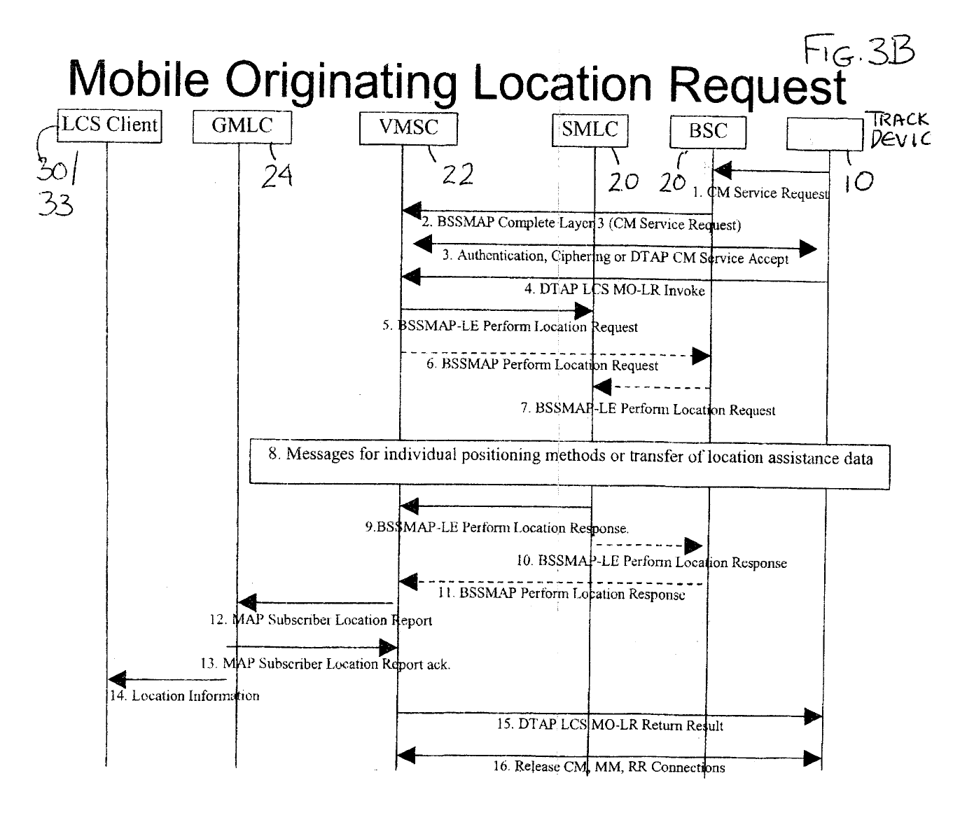

FIG. 3A illustrates one example of the signal flow between the various elements shown in FIG. 2 for the MT-LR. In this Figure the client is shown as the combination of the LAS 30 and the application 33, the MSC 22 is referred to as a Visited MSC (VMSC), MAP refers to Mobile Application Part, and DTAP refers to Direct Transfer Application Part. The various signaling events 5, 6 and 7 between the VMSC 22 and the tracking device 10 take place with the GSM engine 10A.

Referring also to FIG. 4, for notification purposes the movement sensor 10E monitors whether the tracking device 10 is stationary or is moving. When the movement sensor 10E detects movement the tracking device 10 sends, via GSM engine 10A and transceiver 10B, a SMS notification (Notify SMS) message to the LAS 30, via SMS server 25. In response, the LAS 30, which can be seen to include a Notify Server 31A and a Location Tracking Server 31B, notifies the application 33 by a link to the PC 34 or through the cellular system 12 to the MS 32.

Another important task of the movement sensor 10E relates to battery 10D energy conservation. When the tracking device 10 is detected as being stationary for some period of time the tracking device 10 powers off the GSM engine 10A. As a result, in certain uses this “Energy Save” feature can dramatically increase the tracking device 10 operating time. The Energy Save feature may also be used to control the power consumption of external electronics, e.g., the GPS receiver 10F or some other type of tracking device 10 location determination device. Conversely, the movement sensor 10E turns on the GSM engine 10A when movement is detected after a period of no movement, and in response the GSM engine 10A can send a Notification SMS to the external application 33 to indicate the start of movement.

As can be appreciated, when the GSM engine 10A is turned off the tracking device 10 cannot be tracked from the GSM network 12, and the external application client 33 has no access to information regarding the current location of the tracking device 10.

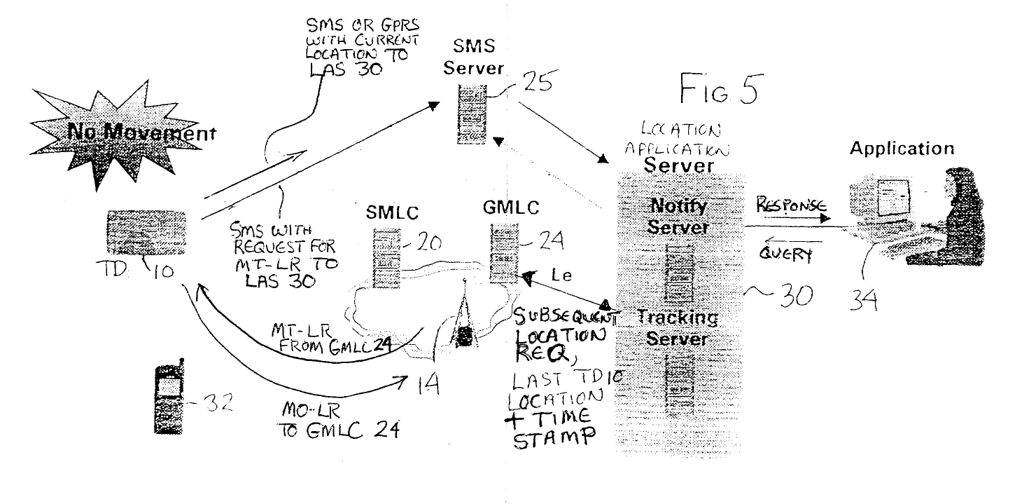

In accordance with an aspect of this invention, and referring to FIG. 5, before the GSM engine 10 turns off, i.e., enters a low or no power consumption state (Energy Save mode), the GSM engine 10A transmits the current location of the tracking device 10 to the network 12, if available (e.g., if the optional GPS receiver 10F is present). This location update procedure can be performed using a Mobile Originated Location Request (MO-LR) operation that is compatible with the GSM network 12 location determining elements (e.g., with the GMLC 24). The tracking device 10 can also send a SMS or a GPRS message to the LAS 30 with an alphanumeric (alpha) string that provides the current location of the tracking device 10. FIG. 3B shows an example of the signaling between the applicable network elements for the case of MO-LR.

However, it is also within the scope of this invention for the tracking device 10 to send the location request, before GSM engine 10A shutdown, directly to the LAS 30 as a data message (e.g., using General Packet Radio Service (GPRS) or SMS). For example, if for some reason the MO-LR is not supported by the network 12, then the tracking device 10 may send a SMS to the LAS 30. This SMS can include an alpha string that requests the LAS 30 to initiate, via the GMLC 24, the Mobile Terminated Location Request operation (FIG. 3A) for the tracking device 10. The MT-LR uses a cellular signaling message, not the SMS facility. The tracking device 10 does not power off the optional GSM engine 10A before the network 12 has been provided, by whatever means is most appropriate, with the current location information.

When the tracking device 10 is in the Energy Save mode with the GSM engine 10A turned off, and the LAS 30 receives a tracking request from the external application 33, the LAS 30 performs a location or position request to the GSM network 12 via the Le interface 30A and the GMLC 24 (see FIG. 5). In response, the GSM network 12 executes a tracking device 10 location request and, after a timeout occurs with no response from the tracking device 10, notifies the LAS 30 that the tracking device 10 is currently not attached. In response, the LAS 30 sends a service-specific message to the external application 33 to inform the external application that the tracking device 10 is currently unavailable. This message includes, preferably, the last reported location of the tracking device 10, and an indication that the tracking device 10 is currently in the Energy Save mode, i.e., an indication that the tracking device 10 is most likely currently stationary at the last reported location coordinates. A time stamp is also preferably provided for indicating the time that the LAS 30 received the location from the GSM engine 10A, just prior to the GSM engine 10A entering the Energy Save mode.

In this manner a user of the location service is informed, via the LAS 30 and the external application 33, that the object to which the tracking device 10 is attached is currently stationary, the assumed current location of the tracked object, and the time when the tracked object became stationary. Thus, any ambiguity as to the current location and state of the tracking device 10 removed.

It can be appreciated that the movement detector 10E may be used as well for other applications, such as with cellular telephone external circuits, e.g. GPS receiver. For example, in a case where the Energy Save mode only turns off the GPS circuitry, the most recent GPS coordinates before power off may be sent to the network 12 with a data message (e.g. GPRS, SMS) to a server, or, for a MS that does not itself enter the Energy Save mode, they may be stored in the mobile station 32. In this latter case the MS 32 will have its current coordinates already stored and promptly available when requested by wireless network 12. This applies as well to the tracking device 10, for an embodiment where only the GPS receiver 10F is powered down, and not the GSM engine 10A and transceiver 10B.

In accordance with this aspect of the invention, when the Energy Save feature is used only for the GPS circuitry, the saved position information is available much faster than when the last coordinates (before becoming stationary) are saved to the network 12 or within the mobile station, such as the MS 32. This is true as the time from GPS wake up (power-on) having GPS coordinates available is typically in the range of 30 seconds to several minutes. This invention thus provides an Energy Save feature with GPS tracking systems, as when the GPS circuitry is always on it consumes an excessive amount of battery power.

Note that during the Energy Save mode the GPS 10F could be periodically switched on to obtain the most recent coordinates, but this approach is also wasteful of battery power, as it can be assumed that the coordinates will not have changed between GPS activations when the tracking device 10, or the GPS-enabled MS 10, is stationary.

As was noted above, in addition to the GPS receiver 10F there are various possible other techniques to determine the position of the tracking device 10, such as E-OTD and Cell ID. Furthermore, and as examples, the foregoing specific message and signaling formats, wireless network types and wireless network architectures are not to be construed in a limiting sense upon the practice of the teachings of this invention.

Thus, while the invention has been particularly shown and described with respect to preferred embodiments thereof, it will be understood by those skilled in the art that changes in form and details may be made therein without departing from the scope and spirit of the invention.

What is claimed is:

1. A method to operate an object location tracking system that comprises a wireless network, comprising:
associating a tracking device with the object, the tracking device comprising a movement sensor;
in response to sensing a cessation of movement, determining the current location of the tracking device; and
placing at least a portion of the tracking device into a reduced power consumption mode of operation.

2. A method as in claim 1, where determining the current location of the tracking device uses a Mobile Originated Location Request operation.

3. A method as in claim 1, where determining the current location of the tracking device uses a Mobile Terminated Location Request operation.

4. A method as in claim 3, where the Mobile Terminated Location Request operation is initiated by sending a message to a location server that comprises an alphanumeric string.

5. A method as in claim 1, where determining the current location of the tracking device comprises using a GPS receiver.

6. A method as in claim 1, where the current location is forwarded to a location tracking system server that is coupled to a wireless network.

7. A method as in claim 1, where the current location is saved in a wireless network in conjunction with a time stamp and, in response to receiving a location update inquiry from a location tracking system server that is coupled to the wireless network, returning the saved location and the time stamp to the location tracking system server.

8. A method as in claim 1, where the current location is saved in the tracking device and, after receiving a location update inquiry, sending the saved current location in response to the location update inquiry.

9. An object location tracking system, comprising:
a tracking device for with associating an object to be tracked, the tracking device comprising a movement sensor, a cellular network-compatible engine and a radio frequency (RF) transceiver;
a cellular network comprising a mobile station location function; and
a location application server that is bidirectionally coupled to the wireless network;
said tracking device, in response to said movement sensor sensing a cessation of movement, initiating a location determination operation via the RF transceiver, the location determining operation resulting in a current location of the tracking device ,becoming known to at least one of the mobile station location function and the location application server, and placing at least a portion of the tracking device into a reduced power consumption mode of operation.

10. An object location tracking system as in claim 9, where the location determining operation uses a Mobile Originated Location Request operation.

11. An object location tracking system as in claim 9, where the location determining operation is initiated by sending a message that comprises an alphanumeric string to the location application server.

12. An object location tracking system as in claim 11, where the alphanumeric string is interpreted by the location application server as a request to cause said mobile station location function to perform a Mobile Terminated Location Request operation.

13. An object location tracking system as in claim 9, where data representing the current location is stored in a memory of said mobile station location function and, in response to receiving a location update inquiry from said location application server, said mobile station location function returns the stored data to said location application server.

14. An object location tracking system as in claim 9, where data representing the current location is stored in a memory of said mobile station location function in conjunction with a time stamp and, in response to receiving a location update inquiry from said location application server, said mobile station location function returns the stored data and the time stamp to said location application server.

15. An object location tracking system as in claim 9, where data representing the current location is stored in a memory of the tracking device and, in response to receiving a location update inquiry, transmitting the stored data in response to the inquiry.

16. An object location tracking system as in claim 9, where data representing the current location is forwarded to said location application server via said mobile station location function.

17. An object location tracking system as in claim 9, where the cellular system comprises a GSM-based system.

18. An object location tracking system as in claim 9, where the cellular system comprises one of a CDMA-based system, a WCDMA-based system, or a TDMA-base system.

19. An object location tracking device, comprising a movement sensor, a cellular network-compatible engine and a radio frequency (RF) transceiver; said tracking device, in response to said movement sensor sensing a cessation of movement, transmitting a message via the RF transceiver to a location server, the message requesting that the location server initiate a Mobile Terminated Location Request operation using said cellular system, and after completion of a tracking device location determination operation, placing at least a portion of the tracking device into a reduced power consumption mode of operation.

20. An object location tracking device, comprising a battery, a movement sensor, a GSM engine and a radio frequency (RF) transceiver; said tracking device, in response to said movement sensor sensing a cessation of movement, initiating a Mobile Originated Location Request operation via the RF transceiver to a GSM network, the Mobile Originated Location Request operation resulting in the generation of data representing a current location of said tracking device, and placing at least the GSM engine into a reduced battery power consumption mode of operation.

21. An object location tracking device, comprising a battery, a movement sensor, a GSM engine and a radio frequency (RF) transceiver; said tracking device, in response to said movement sensor sensing a cessation of movement, transmitting a message via the RF transceiver to a location application server that is coupled to the GSM network, the message comprising an alphanumeric string that requests said location application server to cause said GSM network to perform a Mobile Terminated Location Request operation for said tracking device for obtaining data representing the current location of said tracking device, and placing at least the GSM engine into a reduced battery power consumption mode of operation.

22. An object location tracking device as in claim 21, where the message that comprises the alphanumeric string is a Short Message Service (SMS) message.

23. An object location tracking device as in claim 21, where the message that comprises the alphanumeric string is a data message.

24. An object location tracking device as in claim 21, where the message that comprises the alphanumeric string is a General Packet Radio Service (GPRS) message.

25. An object location tracking device, comprising a battery, a movement sensor, a GSM engine, a radio frequency (RF) transceiver, a memory and a GPS function; said tracking device, in response to said movement sensor sensing a cessation of movement, generating data representing the current location of said tracking device and storing the data into said memory, and placing at least the GPS function into a reduced battery power consumption mode of operation.

26. A method to operate a mobile station with a wireless network, comprising:
in response to sensing a cessation of movement of the mobile station, determining the current location of the mobile station;
transmitting a message from the mobile station towards the wireless network, the message comprising a current location of the mobile station; and
placing at least a portion of the mobile station into a reduced power consumption mode of operation.

27. A method to operate a mobile station with a wireless network, comprising:
in response to sensing a cessation of movement of the mobile station, storing data representing a current location of the mobile station in a memory of the mobile station;
placing at least a location determining system of the mobile station into a reduced power consumption mode of operation; and
in response to receiving a request for the mobile station's location from one of the wireless network or a location server, responding with the stored data.

28. A method to operate an object location tracking system that comprises a wireless network coupled to a location application server that can be queried to initiate a current location determination of an object, comprising:
associating a tracking device with the object, the tracking device comprising a movement sensor;
in response to sensing a cessation of movement, sending a message from the tracking device to the location application server;
calculating the current location of the tracking device in one of the wireless network, with the assistance of the tracking device, or in the tracking device; and
forwarding the calculated location to the location application server.

29. A method as in claim 28, where forwarding the calculated location is supported by the wireless network in a Mobile Terminate Location Request MT-LR operation.

30. A method as in claim 28, where forwarding the calculated location comprises sending a message separate from a Mobile Terminate Location Request MT-LR operation.

31. A method as in claim 28, further comprising placing at least a portion of the tracking device into a reduced power consumption mode of operation.

32. A method as in claim 28, further comprising placing at least a portion of electronics circuitry associated with the tracking device into a reduced power consumption mode of operation.

33. A method to operate an object location tracking system that comprises a wireless network coupled to a location application server that can be queried to initiate a current location determination of an object, comprising:
associating a tracking device with the object, the tracking device comprising a movement sensor;
in response to sensing a cessation of movement, sending a message from the tracking device to the location application server;
in response to receiving the message, initiating a location request operation from the wireless network and performing a Mobile Terminated Location Request (MT-LR) operation;
calculating the current location of the tracking device in one of the wireless network, with the assistance of the tracking device, or in the tracking device; and
forwarding the calculated location to the location application server.

34. A method as in claim 33, where forwarding the calculated location is supported by the wireless network in the MT-LR operation.

35. A method as in claim 33, where forwarding the calculated location comprises sending a message separate from the MT-LR operation.

36. A method as in claim 33, further comprising placing at least a portion of the tracking device into a reduced power consumption mode of operation.

37. A method as in claim 33, further comprising placing at least a portion of electronics circuitry associated with the tracking device into a reduced power consumption mode of operation.

38. A method to operate an object location tracking system that comprises a wireless network coupled to a location application server that can be queried to initiate a network determination of a current location of an object, comprising:
associating a tracking device with the object, the tracking device comprising a movement sensor;
in response to sensing a cessation of movement, sending a message from the tracking device to the location application server, the message comprising information for initiating a current location determination operation for the tracking device;
in response to receiving the current location of the tracking device, storing information that specifies the current location in the location application server;
placing at least a portion of the tracking device into a reduced power consumption mode of operation; and
in response to a query to the location application server for the current location of the tracking device, responding with the stored information.

39. A method as in claim 38, where the message comprises a SMS message.

40. A method as in claim 38, where the message comprises a packet data service message.

41. A method to operate a mobile station with a wireless network, the mobile station comprising or being coupled to a location determination system, comprising:
in response to sensing a cessation of movement of the mobile station, performing at least one of: (a) forwarding most recent location information of the mobile station to the wireless network for storage, (b) forwarding the most recent location information of the mobile station to a location application server for storage via the wireless network, and (c) storing the most recent location information of the mobile station in the mobile station;
at least partially powering down the location determination system; and
in response to a request for a current location of the mobile station, responding with the stored location information.

42. A method as in claim 41, where the mobile station comprises a tracking device for associating with an object.

43. A method as in claim 41, where the mobile station comprises a cellular telephone.

44. A method as in claim 41, where the location determination system comprises a GPS receiver.
